(19) United States
(12) Patent Application Publication
(10) Pub. No.: US 2005/0193400 A1
(43) Pub. Date: Sep. 1, 2005

(54) Roller-cleansing disk for an optical recording and reproducing device

(75) Inventors: Jui-Chiang Lin, Hsinchu City (TW); Tsung-Jung Kuo, Hsinchu City (TW); Hui-Chu Huang, Hsinchu City (TW)

Correspondence Address: BRUCE H. TROXELL, 5205 LEESBURG PIKE, SUITE 1404, FALLS CHURCH, VA, 22041, US

(73) Assignee: LITE-ON IT Corp.

(21) Appl. No.: 11/064,946

(22) Filed: Feb. 25, 2005

(30) Foreign Application Priority Data
Feb. 27, 2004 (TW) 93202948
Jul. 22, 2004 (TW) 93121960

(51) Int. Cl. G11B 17/04

(52) U.S. Cl. 720/621

(57) ABSTRACT

A roller-cleansing disk includes a substrate and an electrostatic layer mounted on one side surface of the substrate. When the roller-cleansing disk is inserted into an optical recording and reproducing device provided with a roller for drawing in or ejecting a CD disk, the electrostatic layer of the substrate contacts and cleans an outer surface of the roller.

### FIELD OF THE INVENTION

The invention relates to a cleansing disk, more particularly to a roller-cleansing disk for an optical recording and reproducing device of slot in type.

### BACKGROUND OF THE INVENTION

An optical recording and reproducing device of slot in type is generally installed in a notebook computer or in an audio-and-video instrument of an automobile for reproducing the information recorded in an optical recording media, such as to play songs from a CD disk.

Referring to FIGS. 1 and 2, perspective and partly exploded views of a conventional optical recording and reproducing device 2 of slot in type are shown to include a casing formed with an elongated slot, and a roller 6 disposed in the casing adjacent to the elongated slot in such a manner that when an optical recording media 4 is inserted into the casing via the slot to contact the roller, the recording media 4 will be drawn into the casing.

Referring to FIG. 3, when the recording media 3 is inserted into the conventional optical recording and reproducing device 2, the roller 6 begins to rotate upon contact with a peripheral portion of the recording media 4, thereby drawing (or ejecting out) the recording media 4 into the device.

One drawback resulting from long term use of the roller 6 of the conventional recording and reproducing device is that an outer surface of the roller 6 will be covered with a layer of dirt 8, as shown in FIG. 4. The dirt 8 does affect the reading/writing abilities of the conventional recording and reproducing device but also disturb the operation of the mechanical structure of the conventional recording and reproducing device.

### SUMMARY OF THE INVENTION

The object of the present invention is to provide a roller-cleansing disk for use in an optical recording and reproducing device that can eliminate the aforesaid drawback resulting from long term use of the conventional optical recording and reproducing device.

A roller-cleansing disk is proposed in accordance with the present invention for use in an optical recording and reproducing device of slot in type. The optical recording and reproducing device is capable of recording and reproducing the information recorded in an optical recording media, and has a roller for drawing into and for pushing the optical recording media out of the device. The roller-cleansing disk includes: a substrate; and an electrostatic layer mounted on one side surface of the substrate, wherein when the roller-cleansing disk is inserted into the optical recording and reproducing device, the electrostatic layer of the substrate contacts and cleans the roller.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 shows a perspective view a conventional optical recording and reproducing device;

FIG. 2 is a partly exploded view, illustrating an interior of the conventional optical recording and reproducing device;

FIG. 3 is a fragmentary sectional view of the conventional optical recording and reproducing device, illustrating how an optical recording media is drawn thereinto;

FIG. 4 is a perspective view of roller employed in the conventional optical recording and reproducing device;

FIG. 5(A) is the preferred embodiment of a roller-cleansing disk according to the present invention;

FIG. 5(B) is the modified preferred embodiment of a roller-cleaning disk according to the present invention;

FIG. 6 illustrates how a roller-cleansing disk of the present invention cleans the roller of the conventional optical recording and reproducing device.

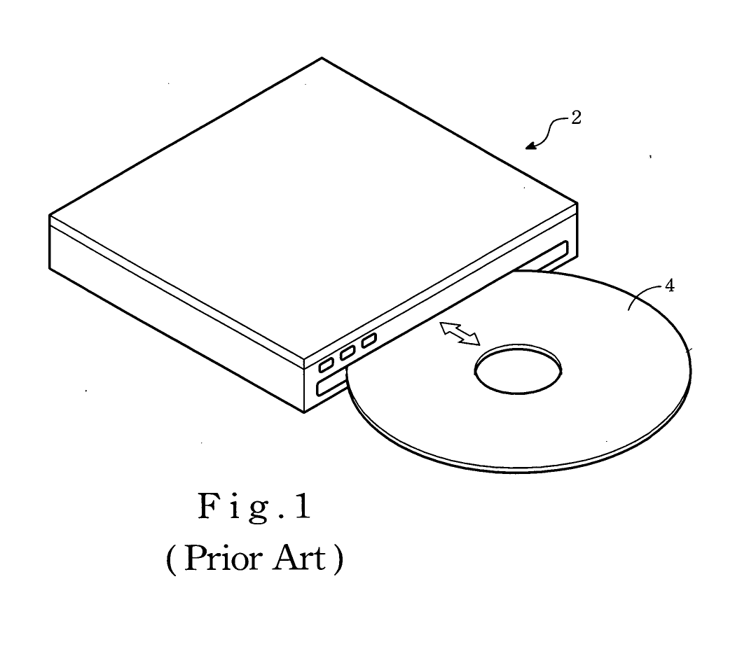

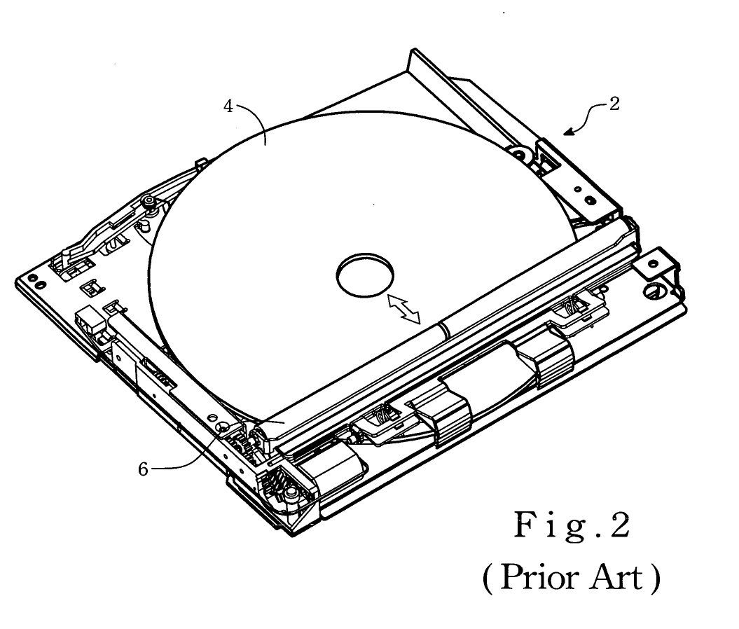

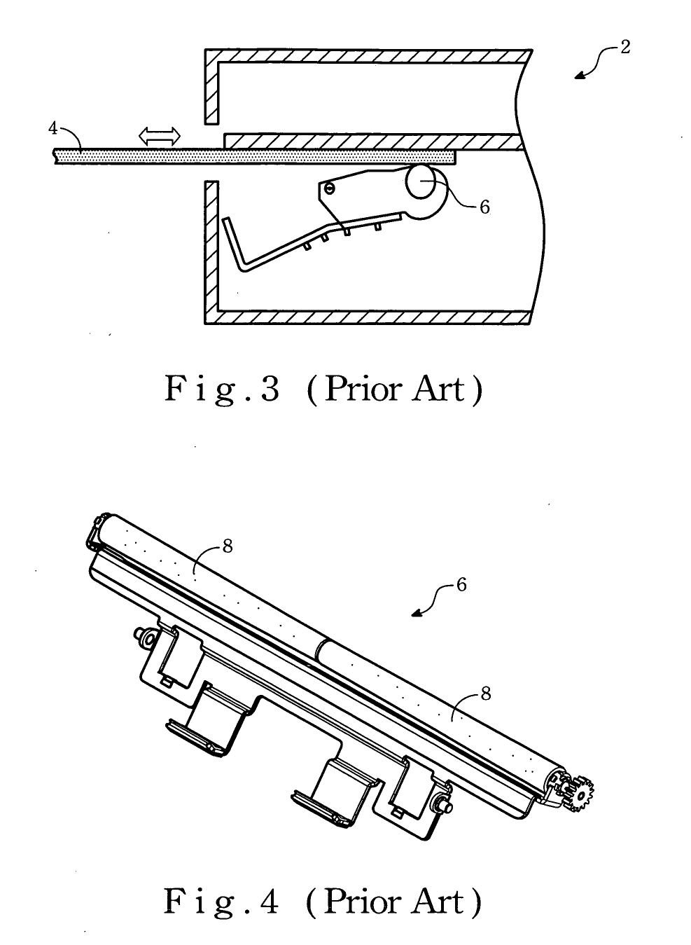

### DETAILED DESCCRIPTIONS OF THE PREFERRED EMBODIMENTS

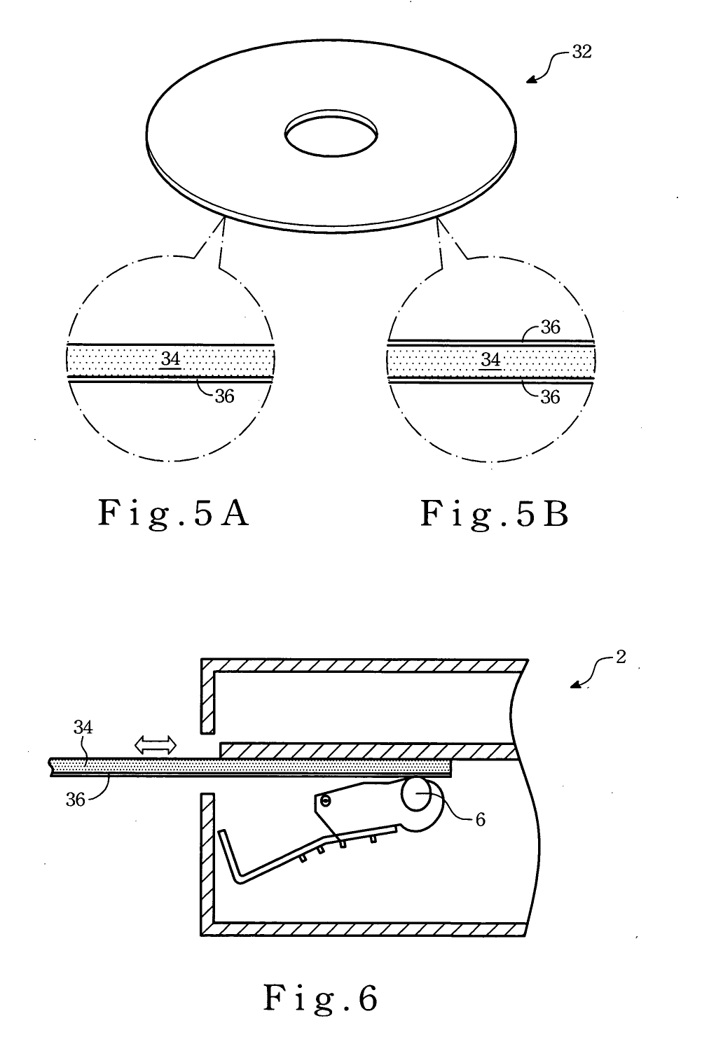

Referring to FIG. 5A, the preferred embodiment according to a roller-cleansing disk 32 of the present invention is used in an optical recording and reproducing device 2 of slot in type, which in term, is installed in a notebook computer (not shown) or in an electronic device (not shown) used in an automobile for reproducing the information recorded in an optical recording media, such as to play songs from a CD disk or compact disk. The preferred embodiment includes a substrate 34 and an electrostatic layer 36 mounted on one side surface of the substrate 34.

Referring to FIG. 6, the optical recording and reproducing device 2 is capable of recording and reproducing the information recorded in an optical recording media, and includes a casing, a support deck disposed within the casing, and a roller 6 mounted rotatably within the casing adjacent to the support deck. The casing is formed with a slot via which the optical recording media, such as a digital audio disk, can be inserted into and/or drawn out from the casing. As to how the roller 6 is driven by to draw in or eject the disk and the driving mechanism thereof is not the relevant features of the present invention, detailed description of the same is omitted herein for the sake of brevity.

When the user of the recording and reproducing device 2 wishes to clean the roller 6, the cleansing disk 32 of the present invention can be inserted into the casing via the slot. The cleansing disk 32 will be drawn into the casing upon contacting with and rotation of the roller 6, wherein the electrostatic layer 36 of the substrate 34 contacts and cleans the outer surface of the roller 6 by virtue of adhesive characteristics of the electrostatic layer 36. The roller-cleansing disk 32 has a configuration identical to that of the optical recording media.

Referring to FIG. 5B, a modified preferred embodiment of the roller-cleansing disk 32 of the present invention is shown to be similar to that of the preferred embodiment, the only difference resides in that two electrostatic layers 36 are mounted respectively on opposite sides of the substrate 34 so as to prolong the service life of the roller-cleansing disk 32.

In another embodiment, the electrostatic layer 36 of the roller-cleansing disk 32 is replaced with an adhesive layer. For example, the adhesive layer can be of twin adhesive. Adopting the adhesive layer can reach the same effect of cleaning the roller 6.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A roller-cleansing disk for an optical recording and reproducing device, the optical recording and reproducing device capable of recording and reproducing the information recorded in an optical recording media, and having a roller for drawing into and for pushing the optical recording media out of the device, the roller-cleansing disc comprising:
a substrate; and
an electrostatic layer mounted on one side surface of said substrate, wherein when the roller-cleansing disk is inserted into the optical recording and reproducing device, said electrostatic layer of said substrate contacts and cleans the roller.

2. The roller-cleansing disk for an optical recording and reproducing device according to claim 1, wherein the optical recording media is a compact disk.

3. The roller-cleansing disk for an optical recording and reproducing device according to claim 1, wherein the optical recording and reproducing device is a slot in type.

4. The roller-cleansing disk for an optical recording and reproducing device according to claim 1, wherein said roller-cleansing disk has a configuration identical to that of the optical recording media.

5. The roller-cleansing disk for an optical recording and reproducing according to claim 1, wherein said roller-cleansing disk includes two of said electrostatic layers which are mounted on opposite sides of said substrate.

6. A roller-cleansing disk for an optical recording and reproducing device, the optical recording and reproducing device capable of recording and reproducing the information recorded in an optical recording media, and having a roller for drawing into and for pushing the optical recording media out of the device, the roller-cleansing disc comprising:
a substrate; and
an adhesive layer mounted on one side surface of said substrate, wherein when the roller-cleansing disk is inserted into the optical recording and reproducing device, said electrostatic layer of said substrate contacts and cleans the roller.

7. The roller-cleansing disk for an optical recording and reproducing device according to claim 6, wherein the optical recording media is a compact disk.

8. The roller-cleansing disk for an optical recording and reproducing device according to claim 6, wherein the optical recording and reproducing device is a slot-in type.

9. The roller-cleansing disk for an optical recording and reproducing device according to claim 1, wherein said roller-cleansing disk has a configuration identical to that of the optical recording media.

10. The roller-cleansing disk for an optical recording and reproducing according to claim 6, wherein said roller-cleansing disk includes two of said adhesive layers which are mounted on opposite sides of said substrate.
